(19) United States
(12) Patent Application Publication
(10) Pub. No.: US 2024/0249047 A1
(43) Pub. Date: Jul. 25, 2024

(54) DESIGN METHOD OF A BRAKE CALIPER

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/378,876

(22) Filed: Oct. 11, 2023

(30) Foreign Application Priority Data
Jan. 19, 2023 (DE) 102023101304.1

(51) Int. Cl. G06F 30/28; G06F 30/15

(52) U.S. Cl. CPC G06F 30/28; G06F 30/15; G06F 2119/02

(57) ABSTRACT

The invention concerns a computer device and a method for designing a brake caliper,
the method being performed under use of a computer device and comprising the following measures:
   a) registering a selection of surfaces of a digital model of the brake caliper, said surfaces bounding a brake fluid cavity of the brake caliper;
   b) generating a brake fluid model that fills the brake fluid cavity;
   c) determining a deformation of the brake caliper model when braking;
   d) determining a volume of the brake fluid model when braking taking into account the determined deformation of the brake caliper model.

### CROSS-REFERENCE TO RELATED APPLICATION

This application is based on and claims priority under 35 U.S.C. § 119 to German Patent Application No. 102023101304.1, filed on Jan. 19, 2023 in the German Patent and Trade Mark Office, the disclosures of which are incorporated herein by reference.

### TECHNICAL FIELD

The invention relates to a design method for determining a brake fluid volume of (and/or in) a brake caliper when braking, the method being performed under use of a computer device. The invention also relates to a computer device that is, in particular, configured to perform a respective method.

### BACKGROUND

The brake caliper may be configured to brake a road vehicle such as a car, a truck or a bus. The brake caliper may be used or usable as part of an automotive brake system, in particular a disc brake system of a vehicle wheel.

Brake calipers that generate brake forces upon increasing the hydraulic pressure of a brake fluid are widely employed in automotive braking. The brake calipers typically comprise a brake piston that is partially received in and delimits a brake fluid cavity of the brake caliper. The brake piston is displaceable by varying the pressure of the brake fluid in the brake fluid cavity. The brake piston rests against at least one brake pad that is displaceable along with the brake piston to e.g. contact a brake disc for generating a brake force.

The brake caliper is deformable under load which is accompanied by a deformation of the brake fluid cavity. Said deformation may occur in both radial and axial directions with respect to a displacement axis of the brake piston. This is known to result in excess intakes of brake fluid in addition to the intake resulting from a displacement of the brake piston. Further factors that contribute to this excess intake of brake fluid e.g. concern a deformation of the seal and a compressibility of the brake fluid.

The excess intake of brake fluid volume under load is an important design parameter. It is often subject to a threshold that must not be exceeded. This threshold is set to limit impacts on brake pedal feel and to ensure a desired braking performance.

So far, when designing brake calipers virtual models or, put differently, digital models thereof are examined to determine the excess brake fluid intake. This examination is typically based on finite element methods (FEM) and more particularly on simulations that are based on FEM. Essentially, deformations of all relevant elements delimiting a brake fluid cavity are determined to subsequently compute the deformation and volume of said brake fluid cavity. However, it has been found that this process is not straightforward, computationally inefficient and prone to inaccuracies.

In more detail, in order to take into account the various factors contributing to the excess brake fluid intake, the simulation is so far split up into various tasks. Performing only a single comprehensive simulation in which all of the below discussed deformations, deflections and compressibility are taken into account has been found to be computationally costly. Also, it often leads to so-called convergence problems, e.g. when the simulation software is not able to meet desired constraints.

Accordingly, known solutions include a three-dimensional simulation for determining an axial deflection of a brake caliper housing under load. This includes selecting only certain reference nodes of a meshed digital caliper model, these reference nodes being considered critical and representative for an overall deformation. Further, two-dimensional simulations are performed to determine a seal deformation and a radial deflection of the brake caliper housing under said same load. These two-dimensional deformations can be multiplied by a circumferential dimension to determine a volumetric dimension of the deformation. As a separate step, a brake fluid compression under said load is analytically computed.

From each of these simulations and computations, contributions to a change in volume of the brake fluid cavity and a resulting brake fluid intake are received to compute an overall volume (in particular increase in volume) of the brake fluid cavity and/or an overall excess brake fluid intake under load. Safety factors may be included in this process, said safety factors being derived from experiments or experience.

Drawbacks resulting from this procedure concern a lack of precision due to considering only selected reference nodes and partially only performing two-dimensional simulations. Further, the procedure is computationally expensive because it can only be applied for one certain load (e.g. in form of a certain applied hydraulic brake pressure). Therefore, the above computations need to be repeated for a number of brake loads in order to be able to approximate a continuous curve of a parameter of interest (e.g. excess brake fluid intake) as a function of the brake load. This approximation further reduces precision.

### SUMMARY

The present invention is thus directed to the object of providing a more accurate, but computationally more efficient approach to determining deformations of a brake caliper and in particular determining a changing volume of its brake fluid cavity and associated brake fluid intake under load.

This object is solved by the subject matter according to the attached independent claims. Advantageous embodiments are set out in this description, in the figures and in the dependent claims.

Accordingly, a method for determining a brake fluid volume of and/or in a brake caliper when braking is suggested. The method is performed under use of a computer device (e.g. a computer device as set out below) and comprises the following measures:
a) registering a selection of surfaces of a digital model of the brake caliper, said surfaces bounding a brake fluid cavity of the brake caliper, in particular wherein the brake caliper model comprises a number of finite elements or is discretized to comprise a number of finite elements;
b) generating a brake fluid model (e.g. being discretized and/or comprising a brake fluid mesh) that fills the brake fluid cavity (and thus has a certain volume, in particular an initial volume occurring without brake activities);
c) (e.g. numerically) determining a deformation of the brake caliper model when braking, in particular based on a finite element method;
d) (e.g. numerically) determining a volume of the brake fluid model when braking taking into account the determined deformation of the brake caliper model.

This method differs from existing prior art in that the volume of the brake fluid model (and thus the volume of the brake fluid cavity) may be regarded as a degree of freedom, i.e. as a variable parameter of interest that is determined by the overall method. In the existing prior art, the individual deformations and displacements of the split-up simulations represent the degrees of freedom with the volume of the brake fluid cavity being only subsequently computed based thereon.

By instead proceeding as set out herein, the change in volume of the brake fluid cavity can directly be computed in one coherent simulation process. Also, this single simulation may include a continuous variation of a brake load e.g. up to a maximum brake load. This is different from the so-far performed step-wise and separate simulations for each brake load level up to a maximum brake load. Still further, fluid characteristics such as its compressibility may directly be considered during the simulation which is more precise than subsequently correcting simulation results based on an assumed compressibility.

Overall, the suggested method is thus faster, computationally more efficient and more accurate than the existing procedure.

The brake caliper model may e.g. be a CAD model (Computer Aided Design). It may be provided in an already discretized form, e.g. in a meshed from. Alternatively, the method may include a discretization (e.g. a meshing) of said model. The selection of surfaces may be performed in a non-discretized state (with the discretisation being performed subsequently after the selection) or in an already discretized state of the brake caliper model.

The discretisation may generally include dividing the CAD model into finite elements or, in other words, modelling the brake caliper and/or its virtual model by discrete finite elements, such as nodes or other primitives. A finite element may generally be marked by its (preferably three-dimensional) coordinates in a coordinate system used by the method.

The selection according to measure a) may directly or indirectly be performed by a user, said user e.g. using the computer device to perform the selection. For example, the user may identify those surfaces that bound the brake fluid cavity. This may include identifying surfaces that are not yet contacted by the brake fluid, but are designed and configured to be contacted by brake fluid under load. Such surfaces may e.g. be comprised by a seal or groove as discussed below. The surfaces may not yet be contacted e.g. because they are in direct physical contact with an opposite surface when no brake action is performed. However, upon braking, these surfaces may move apart from one another, thereby bounding a volume into which brake fluid may stream, i.e. a volume contributing to the overall volume of the brake fluid cavity.

The computer device may register said selection upon a user inputting an identification command with respect to the relevant surfaces, e.g. by selecting them from a list. Alternatively, the user may point or click at said surfaces or otherwise select or identify them in a visual representation of the digital model. The computer device may comprise an input interface to receive said identification and/or selection, such as a mouse, a touch-sensitive display, a keyboard, a microphone or a camera. Alternatively, the selection may be registered by reading it out from an internal or external storage device (e.g. an online storage device or cloud storage device). In this case, the input interface may be or comprise a data interface for connecting to said internal or external storage. The selection may then optionally be performed by using some other computer device and storing the result in respective storage device.

The registering of the selected surface may include loading said selection (e.g. information concerning and/or identifying said selection) into a memory of the computer device. The terms memory and storage device are used interchangeably herein.

Any of the measures b) to d) and in particular any combination thereof may be performed without any direct or indirect user input. Rather, the computer device may independently and/or autonomously perform these measures. This also applies to measure a) in which at least the registering (but not necessarily the selection) may be performed autonomously by the computer device.

An overall result derived from performing the measures may be output to a user, e.g. in form of a fault notification or non-fault notification discussed below and/or in form of computed values (e.g. concerning the volume increase of the brake fluid cavity or the amount of excess brake fluid intake).

As a result, the method may enable determining whether a given brake caliper model is suitable or not under given brake loads with respect to its deformation characteristics and associated excess brake fluid intakes.

Based on the selection of measure a), a (preferably three-dimensional) extension of each surface may be determined. Also, it may be determined which finite elements are comprised by said surface e.g. based on calculating distances between finite elements and said surface. These distances are zero when a finite element is comprised by a surface.

In the context of measure b), the brake fluid model may be provided (or, in other words, may be added, defined, generated or set) by adding it into the space confined by the selected surfaces, i.e. into the brake fluid cavity. Apart from its position and extension, parameters of the brake fluid model may be pre-set, such as the type of fluid (typically brake fluid oil) and its associated fluid parameters or, in other words, material characteristics. Put differently, by way of measure b), the brake fluid cavity may be automatically filled with a brake fluid model.

The brake fluid model may comprise a number of finite elements, in particular solid elements having a low stiffness, e,g, less than 10% of the stiffness of solid elements of a brake caliper housing. The filling of the brake fluid cavity with the brake fluid model and in particular defining its optional finite elements may implemented by known algorithms. These algorithms may automatically mesh the brake fluid cavity, thereby e.g. defining a large number of hexahedron, tetrahedrons or pentahedrons as finite elements.

At least measures c)-d) may at least partially be performed simultaneously. For example, at least part thereof may be performed in an interleaved, coupled and/or reciprocal manner. In one example, at least measures c)-d) are comprised by a coupled analysis, such as a fluid-structure interaction (FSI) analysis. For example, at least measures c)-d) may be comprised a (e.g. numeric) computation and/or simulation considering fluid-structure interactions.

Fluid-structure interactions are typically accounted for by multiphysics simulations in existing software tools. In such multiphysics simulations, data may be automatically exchanged between a fluidic simulation solver and a mechanical simulation solver and/or between computational fluid dynamics (CFD) (e.g. used for determining fluid characteristics) and finite element analysis (FEA) (e.g. used for determining mechanical characteristics). In other words, fluid-structure interactions may include a coupled simulation and/or a coupled analysis of fluidic and mechanical behaviours.

While solutions exist for computing fluid-structure interactions based on virtual models, these solutions have so far not been applied in the present context of brake calipers and for determining brake fluid intakes. Rather, a focus of fluid-structure interactions typically concerns determining dynamic characteristics of a flowing liquid and parameters affected thereby, such as local heat transfers. However, for the present task such dynamic characteristics are of minor relevance.

Rather, in the present case, in particular the volumetric difference between a state marked by an initial brake fluid pressure without brake activity and a state marked by a final pressure when applying the brake is of interest. This resembles comparing quasi-static states of the brake instead of examining dynamic fluid flows that e.g. occur while varying the brake pressure.

It is thus an insight of this invention that FSI is nevertheless useful in the present scenario and has the potential to solve the present object.

In sum, according to a further embodiment, at least measures c) and d) may be implemented as part of a fluid-structure interaction analysis or, in other words, as part of a computation based on and/or taking account of fluid-structure interactions.

In the context of measure c), standard FEM algorithms may be employed which take account of load cases or load conditions that occur during braking. Any prescribed boundary conditions that e.g. concern (in particular local) degrees of freedom of movement may be taken into account. In one example, a brake pressure that occurs within the brake fluid cavity when braking may be set as a load case. In particular, a continuous increase or other variation of said brake pressure may be considered that occurs when braking. It is generally known to determine deformations of structures under fluidic pressures with help of finite element methods.

In the context of measure d), the volume of the brake fluid model that is affected by the deformed brake caliper may be determined. Generally, the volume of brake fluid model and in particular an increase of said volume may be composed of a share resulting from the displacement of the brake piston as well as a share resulting from the deformation of the brake caliper, in particular a brake caliper housing and/or a the seal of said brake caliper. The present simulation may jointly compute these shares by, e.g. given a load case of a certain brake pressure, determining all piston movements and brake caliper deformations that lead to an additional brake fluid intake. In this context, a constant homogeneous compressibility within the brake fluid model may be assumed. At nodes of this mesh, the volume may be determined as new degrees of freedom by a summed deformation in the various spatial directions. This may resemble or take account of an excess brake fluid intake.

Generally, the method may take a displacement of the brake piston and/or an associated intake of brake fluid volume for achieving said displacement into account, e.g. by defining the respective states and/or boundary conditions. Additionally, the method may take elastic deformations of the brake caliper (in particular the brake caliper housing) into account, in particular by way of measure c) discussed above. All of these effects on the volume of the brake fluid model may be computed directly within and/or as part of the method and in particular as part of a single coherent simulation comprising or being comprised by said method.

According to a further embodiment, in measure d) the volume of the brake fluid model is also determined based on a compressibility of the brake fluid model, e.g. of the brake fluid that is modelled by said brake fluid model.

The compressibility of the brake fluid model may be non-linear. For example, it may be non-linear as a function of an applied fluid pressure and/or an associated brake load. Contrary to existing solutions, the compressibility and in particular optional non-linear characteristics thereof can thus directly be taken into account during a single simulation process. This is different from subsequently adjusting an already computed/simulated volume of the brake fluid which leads to computational inefficiencies and inaccuracies.

According to one embodiment, the method further comprises determining a change of a volume of the brake fluid model when changing from a state before braking to a state when braking. This may be equivalent to and/or include determining a volume of an excess brake fluid intake when braking. In this context, the method may include determining an initial volume of the brake fluid model before braking.

The method may also comprise determining an excess brake fluid intake resulting from deformations of the brake caliper. This excess brake fluid intake may concern the share of the volumetric increase of the brake fluid (model) that cannot be attributed to an expected and desired increase when displacing the brake piston. In other words, the excess brake fluid intake may represent a difference between the overall change of volume of the brake fluid model and a share attributed to a piston displacement (and without brake caliper deformations). The share attributed to a piston displacement may be analytically computed and determined by the geometries of the brake piston and brake caliper housing. Thus, the excess brake fluid intake may generally be associated with and/or may be a function of the overall change of volume of the brake fluid model.

The method may further comprise generating a fault notification in case a threshold criterion is met or exceeded. This threshold criterion may be associated with and/or may be a function of a volume of the brake fluid model, e.g. of a change of said volume as discussed above. The threshold criterion may e.g. concern an allowable overall change in volume of the brake fluid model (e.g. between a state before braking and a state when braking). In this case, the threshold criterion may be a direct function of and/or correspond to a change in volume of the brake fluid model. Additionally or alternatively, the threshold criterion may e.g. concern an allowable amount of excess brake fluid intake. In this case, the threshold criterion may be regarded as being at least indirectly associated with and/or as being a function of the change of the volume of the brake fluid model, see above.

According to further embodiment, measure c) comprises setting a pressure load exerted by a brake fluid in the brake fluid cavity on the brake caliper when braking. This pressure load may define a main load case when braking. This load case may result in further reaction forces, e.g. when resting against brake pads or a brake disc. In a generally known manner, this reaction forces may be accounted for by FEM algorithms, e.g. based on suitably defined boundary conditions or, in other words, constraints.

The method may generally include (in particular in the context of measure c)) determining and/or taking into account deformations of other components of a brake arrangement comprising the brake caliper. These components may e.g. include a shim, a brake pad or a brake disc. Given that the brake caliper at least indirectly rests against these components, its deformation may thus be more accurately determined.

In one example, the brake caliper model comprises:

a brake caliper housing and/or a brake piston that is displaceably received in the brake fluid cavity and/or a seal that contacts an outer circumference of the brake piston and fluidically seals the brake fluid cavity.

According to a further embodiment, the method further includes adjusting at least one of the following of the brake caliper model in view of the determined volume of the brake fluid model:
at least one geometric characteristic (e.g. a wall thickness, a dimension of a solid structure, a distance between selected surfaces) of at least one component of the brake caliper model;
at least one material characteristic (e.g. by varying the type or composition of a used material) of at least one component of the brake caliper model.

These adjustments may be automatically performed or suggested by the computer device based on optimization algorithms. The adjustments may e.g. serve to limit the extent of elastic deformations of the brake caliper model (in particular of its housing) that may cause an excess brake fluid intake. Alternatively, the adjustments may be implemented by a user. Generally, the adjustments may be performed (and e.g. automatically initiated) when the above discussed threshold criterion is not met. The adjustments may be made to refine and/or finalize a design of the brake caliper model, in particular in order to manufacture a real-world brake caliper in accordance with (or corresponding to) said finalized brake caliper model.

The adjustments may generally serve to reduce the brake fluid volume, e.g. by stiffening the brake fluid housing.

In still another example, the method further includes defining a final geometry of the brake caliper model (e.g. by adjusting said model and an initial geometry thereof in the above manner) and manufacturing a brake caliper in accordance with said final geometry of the brake caliper model. The manufacturing may include controlling any manufacturing device (e.g. of the below discussed kind) to produce at least selected components of the brake caliper and/or to produce (e.g. casting or forging) molds for producing at least the brake caliper housing.

The invention also concerns a method for manufacturing a brake caliper, the method comprising: applying a method according to any of the aspects disclosed herein to at least two different brake caliper models and selecting one of the brake caliper models for manufacturing the brake caliper in accordance with said selected brake caliper model. The different brake caliper models may e.g. be generated by iteratively modifying an initial brake claiper model to meet a design goal, e.g. with respect to the brake fluid volume (see threshold criterion above). Each modification may result in a further (e.g. adjusted)brake caliper model being generated.

The invention also concerns a computer device. The computer device may generally be configured to perform a method according to any of the examples disclosed herein. Any embodiments and variants of features discussed in the context of the method may equally apply to similar features of the computer device, and vice versa.

Specifically, the computer device may be configured to perform the following measures:
a) registering a selection of surfaces of a digital model of the brake caliper, said surfaces bounding a brake fluid cavity of the brake caliper;
b) generating a brake fluid model that fills the brake fluid cavity;
c) determining a deformation of the brake caliper model when braking;
d) determining a volume of the brake fluid model when braking taking into account the determined deformation of the brake caliper model.

Again, measures c) and d) may be performed in a coupled manner, in particular as part of a fluid-structure interaction analysis.

The computer device may comprise a memory and a processor, e.g. a CPU. The memory may store computer instructions that, when executed by the processor, may prompt the computer to perform the measures a) to d). The memory may store the digital brake caliper model, e.g. in form of a CAD model. For example, the computer device may be configured to execute a FEM algorithm, a CFD algorithm and/or a FSI algorithm according to any of the examples discussed herein.

In one example, the selection of surfaces in measure a) may be registered via an input interface of the computer device. Examples of said input interface have been discussed above.

Additionally alternatively, the computer device may further be configured to output a fault notification via an output interface in case a threshold criterion associated with the volume of the brake fluid model is met or exceeded. The output interface may e.g. be a display and/or a speaker. Accordingly, the fault notification may be a visual notification and/or an audio notification.

In a further embodiment, the computer device is further configured to generate a dataset defining a final geometry of the brake caliper model. For example, this dataset may be generated when the above threshold criterion is not met and/or upon a respective user command. Said dataset may also include information about a material of any of the components of the brake caliper model.

Additionally alternatively, the computer device may be configured to generate a control dataset (e.g. including control commands) by means of which at least one manufacturing device can be controlled to produce at least one component of a brake caliper in accordance with the brake caliper model and/or to produce at least one (e.g. casting or forging) mold that is usable to produce said at least one component. The manufacturing device may e.g. be a casting device, an additive manufacturing device (e.g. a selective laser melting device) or a milling device (to e.g. produce the brake piston or optional casting or forging molds).

### BRIEF DESCRIPTION OF DRAWINGS

Embodiments of the invention are discussed below with respect to the attached schematic figures. Throughout the figures, same reference signs may be used for same of similar features.

FIGS. 1-2 are sectional drawings which show a brake caliper and when not braking (FIG. 1) and when braking (FIG. 2).

FIG. 3 is a flow for illustrating a sequence of measures of a method according to an embodiment of the invention.

FIG. 4 is a highly schematic illustration of a computer device according to an embodiment of the invention.

### DETAILED DESCRIPTION

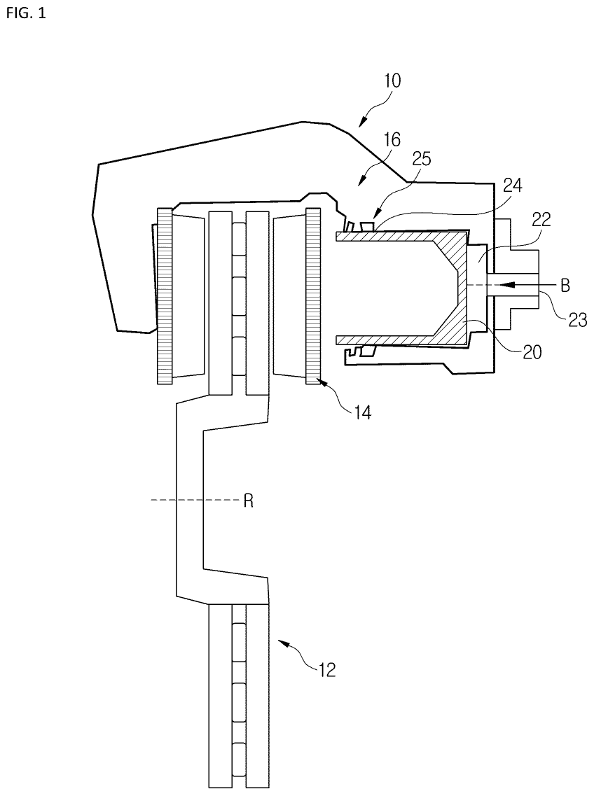

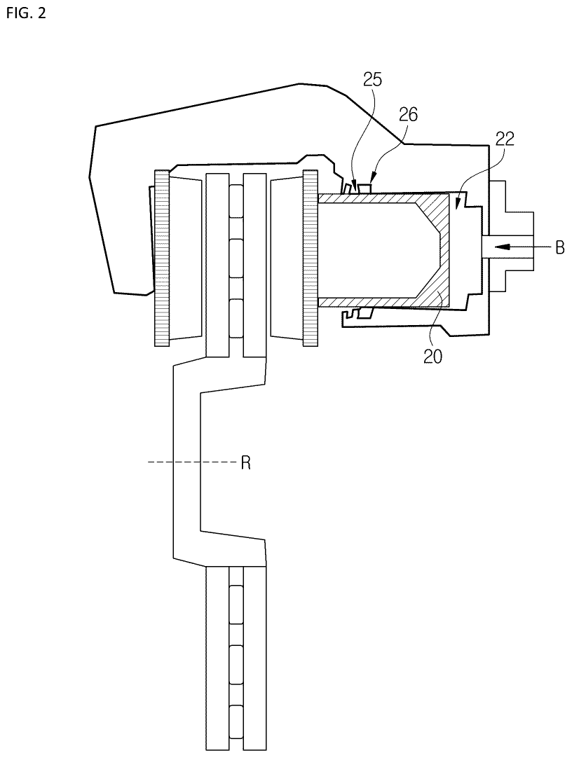

FIGS. 1-2 shows a disc brake arrangement 10 of a vehicle wheel brake. The disc brake arrangement 10 comprises a brake disc 12, part of which is received between a pair of brake pads 14. The brake disc 12 rotates about a rotation axis R together with a non-illustrated vehicle wheel. In a generally known manner, the brake pads 14 can clamp the brake disc 12 in between them to generate a braking effect.

It is noted that FIGS. 1-2 are sectional views with the sectional plane comprising the rotation axis R.

FIGS. 1-2 also show a brake caliper 16. Features of this brake caliper 16 are also comprised by a digital model of said brake caliper 16 used by the presently disclosed method and computer device. Put differently, the features of the brake caliper 16 of FIGS. 1-2 are likewise comprised by and correspond to features of a digital model of said brake caliper 16.

Generally, in the present disclosure references to the brake caliper 16 and its features may equally apply to a model of the brake caliper 16 and its features.

The brake caliper 16 is configured to exert a braking force onto the brake pads 14. For doing so, the brake caliper 16 operates according to known floating caliper principles. It comprises a brake caliper housing 18 in which a displaceable brake piston 20 is received. A space in between the brake caliper housing 18 and brake piston 20 defines a brake fluid cavity 22 in which a brake fluid is received. A ring-shaped seal 24 is held in a circumferential groove 25 of the brake caliper housing 18 and contacts an outer circumference of the brake piston 20. The seal 24 thus fluidically seals the brake fluid cavity 22 with respect to the surroundings.

In FIG. 1, the streaming in of brake fluid through a connection port 23 to activate the brake is indicated by an arrow B. This stream leads to pressure increase in the brake fluid cavity 22 to displace the brake piston 20 into the active braking position of FIG. 2.

As a result of the displacement, a volume of the brake fluid cavity 22 increases. Part of the increase may be a direct and easily predictable result of the brake piston 20 being moved relative to and partially out of the brake caliper housing 20, thus increasing the volume of the brake fluid cavity 22 accordingly.

Further factors contributing to the increasing volume of the brake fluid cavity 22 concern non-illustrated elastic deformations of e.g. the brake caliper housing 18, the brake piston 20 and the seal 24. In the latter case, a generation of a gap 26 in between the circumferential groove 25 and the seal 24 is indicated in FIG. 2. Said gap 26 is immediately filled with brake fluid and thus adds to the volume of the brake fluid cavity 22. Such additional contributions are not as directly predictable and represent an excess brake fluid intake, e.g. in excess to the brake fluid intake directly resulting from the above-discussed displacement of the brake piston 20.

As discussed above, it is so far been computationally expensive and marked with low accuracy to determine the volume of the brake fluid cavity 22 while taking account of all of the possible volume increasing factors.

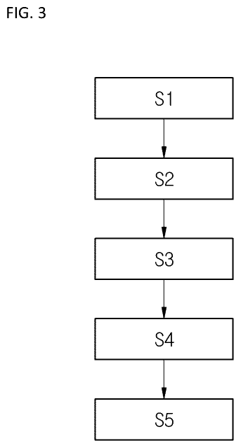

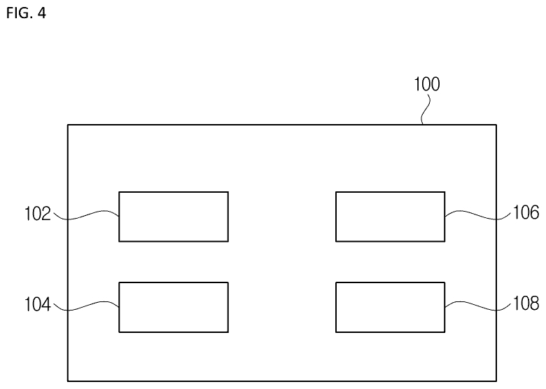

FIG. 3 is a flow diagram illustrating a method according to an embodiment of this invention. This method is performed under use of a computer device 100 discussed with respect to FIG. 4 below.

In a step S1 (that may optionally be outside of the scope of the method), a digital brake caliper model is generated. This may include generating the model by CAD software tools.

In a step S2 (that may optionally be outside of the scope of the method), a selection of surfaces that bound a fluid brake cavity of the digital brake caliper model is performed.

In FIGS. 1, 2, these surfaces include an outer surface of the brake piston 20 and an inner surface of the brake caliper housing 18 (e.g. of a bore in which the brake piston 20 is received). Also, these surfaces include a face of the seal 24 facing to the right in FIGS. 1, 2, an opposite face of the circumferential groove 25 and a bottom face of the circumferential groove 25. These faces delimit the gap 26 of FIG. 2. Even though this gap is not yet formed in FIG. 1, the surfaces may still be selected, but in the state of FIG. 1 contribute a volume share of zero to the brake fluid cavity 22.

In sum, all surfaces that may potentially delimit the brake fluid cavity 22 with respect to any of the operating states of the brake caliper 16 are selected upfront by a user.

It is to be noted that e.g. by employing known contact definitions or contact thresholds, an algorithm used for performing the present method can reliably detect to which degree a certain surface is actually covered and/or contacted by the brake fluid. For example, for each finite element of a respective surface, a contact criterion (e.g. the falling below of a minimum distance threshold) with respect to the brake fluid model may be checked, e.g. prior to and/or after deformation. This, too, may help to determine an extent and thus overall volume of the brake fluid model.

In the present embodiment, the selection includes the user pointing at or clicking on said surfaces in a visual representation of the digital brake caliper model. This includes using an input interface 106 of the computer device 100, such as a mouse or keyboard (see FIG. 4).

In a step S3, the selected surfaces are registered or, put differently, are recognized or are received by the computer device. In the present embodiment, this may take place simultaneously to the selection of step S2.

In a step S4, the computer device 100 (in particular automatically) provides a brake fluid model that fills the brake fluid cavity 22. This includes filling the brake fluid cavity 22 that is bound by the selected surfaces with finite elements. In particular, volumetric finite elements having material characteristics of the brake fluid may be used for filling the brake fluid cavity 22.

In a step S5, a deformation of the brake caliper model when braking is determined. This is implemented based on a finite element method or, in other words, a finite element analysis. For doing so, the brake caliper model may already be provided in a discretized form or may be discretized in step S5. As a load case, a certain fluid pressure within the brake fluid cavity 22 for activating the brake is set (in particular upfront by a user using the computer device 100). Also, constraints are defined (in particular upfront by a user using the computer device 100) with respect to movements and reaction forces that may occur when activating the brake.

In a steps S6, a volume of the brake fluid model when braking is determined (in particular automatically by the computer device 100), e.g. based on a CFD analysis. In this process, the determined deformation of the brake caliper model and in particular the resulting shape and volume of the brake fluid cavity 22 are taken into account.

Contrary to their sequential representation in FIG. 3, steps S5 and S6 are performed at least partially simultaneously as part of a FSI analysis according to any of the variants discussed herein.

In step S7, the volume of the brake fluid model during brake activation is determined. Optionally, this may include determining an excess brake fluid intake as discussed earlier herein.

In step S8, it is determined whether the volume of the brake fluid model when activating the brake (and/or its associated excess brake fluid intake) meets or exceeds a threshold criterion. If that is the case, a fault notification is generated and output by an output interface 108 of the computer device 100 (see FIG. 4).

FIG. 4 schematically illustrates a computer device 100 according to an embodiment of the invention. The computer device 100 comprises a processor 102, a memory 104, an input interface 106 and an output interface 108. The memory 104 stores a virtual model of a brake caliper and computer instructions. When executed by the processor 102, the computer instructions prompt the processor 102 to perform a method according to FIG. 3 or according to any other embodiment disclosed herein.

In this context, a selection of surfaces (see step S2 of FIG. 3) is registered via the input interface 106. Also, in case a fault notification is generated according to step S8 of FIG. 3, it is output via the output interface 108.

What is claimed is:

1. A method for Designing a brake caliper,
the method being performed under use of a computer device and comprising the following measures:
a) registering a selection of surfaces of a digital model of the brake caliper, said surfaces bounding a brake fluid cavity of the brake caliper;
b) generating a brake fluid model that fills the brake fluid cavity;
c) determining a deformation of the brake caliper model when braking;
d) determining a volume of the brake fluid model when braking taking into account the determined deformation of the brake caliper model.

2. The method according to claim 1,
wherein at least measures c) and d) are implemented as part of a fluid-structure interaction analysis.

3. The method according to claim 1,
wherein in measure d), the volume of the brake fluid model is also determined based on a compressibility of the brake fluid model.

4. The method according to claim 3,
wherein the compressibility of the brake fluid model is non-linear.

5. The method of according to claim 1,
further comprising generating a fault notification in case a threshold criterion associated with the volume of the brake fluid model is met or exceeded.

6. The method of according to claim 1,
wherein measure c) comprises setting a pressure load exerted by a brake fluid in the brake fluid cavity on the brake caliper when braking.

7. The method of according to claim 1,
wherein the brake caliper model comprises a brake caliper housing and at least one of:
a brake piston that is received in brake fluid cavity;
a seal that contacts an outer circumference of the brake piston and fluidically seals the brake fluid cavity.

8. The method of according to claim 1,
further including adjusting at least one of the following of the brake caliper model in view of the determined volume of the brake fluid model:
at least one geometric characteristic of at least one component of the brake caliper model;
at least one material characteristic of at least one component of the brake caliper model.
